(19) United States
(12) Patent Application Publication
(10) Pub. No.: US 2020/0337939 A1
(43) Pub. Date: Oct. 29, 2020

(54) CONTOURED SOFT TISSUE THERAPY TOOL

(71) Applicant: Maverick Sports Medicine, Inc., Redmond, WA (US)

(72) Inventor: Jeffrey R. Rodgers, Bellevue, WA (US)

(21) Appl. No.: 16/392,319

(22) Filed: Apr. 23, 2019

(51) Int. Cl. A61H 15/00

(52) U.S. Cl. CPC A61H 15/0092; A61H 2201/1692; A61H 2201/1695; A61H 2015/0014

(57) ABSTRACT

The present disclosure is directed to a soft tissue massage device that includes a compliant cylindrical core or cylinder formed of compressible material, the cylinder having an external surface with at least one pair of bulbous protrusions or orbicular sections that cooperate to form a symmetrical central valley having sloped sides. A second pair of bulbous protrusions or orbicular sections is formed on the core that cooperate with the first pair of bulbous protrusions or orbicular sections to form first and second valleys that are asymmetrical. Smaller knobs are formed, preferably over the entire surface of the core, including the first and second pairs of bulbous protrusions or orbicular sections. An axle with hand grips may be utilized to achieve different effects.

### BACKGROUND

### Technical Field

The present disclosure is directed to non-invasive therapeutic devices for use on muscles, ligaments, and tendons and, more particularly, to a cylindrical roller and therapy tool having soft tissue massage elements formed on an outer surface for selective application by a user.

### Description of the Related Art

Massaging of muscles, tendons, and ligaments is known to provide therapeutic benefits in overcoming injuries to soft tissues, as well as addressing muscle tightness, lack of flexibility, soft tissue adhesions, knots, and scar tissues. The use of manual massage is also known to maintain good health of these tissues. Countless tools and massage aids have been developed to provide a mechanical advantage and to relieve stress on the hands of the massage provider.

Recently, large scale devices have been utilized, such as a large tube or a ball, in which the weight of the body is applied to the device. By positioning the body in various orientations with respect to the tube or the ball and rolling the body across the device such that the device rolls on a supporting surface, the application of greater force is provided to the affected tissue. For example, one known device is nothing more than a tubular roller formed of foam material on which a user balances their body, typically in a reclining position, either on their back, side, or stomach. The roller has a smooth outer surface and is not supported on the ends. Some of these devices have textured surfaces to improve the effect of compressing soft tissue beneath the skin. One such device known as the RumblerRoller® manufactured and distributed by STI in Baton Rouge, La., incorporates bumps that have a firm yet flexible construction for continuously kneading the body. The closely spaced bumps (less than 2 inches apart) are designed to reduce area contact with the device while increasing pressure to provide a deeper, more penetrating action. The disadvantage of this design is that users cannot selectively position any one of the bumps over a desired area while not having bumps applied anywhere else on the body.

Another approach is described in U.S. Pat. No. 4,142,519 (Ferguson), which shows a massage roller of uniform diameter over its entire length, “the surface of which is studded with flanged protuberances that function to dislodge and remove dry or dead skin during the massage treatment.” The roller is supported on a fixed stand that has cords on either side for grasping by the user. The device is cumbersome at best and is unsuitable for portability and versatility of use.

### BRIEF SUMMARY

The present disclosure is, in one implementation, directed to a contoured soft tissue therapy device that includes a cylinder formed of compressible material, the cylinder having an external surface.

In accordance with one implementation of the present disclosure, a contoured soft tissue therapy roller is provided. The roller includes a cylinder having a first end, a second end, a longitudinal axis, and a longitudinal axial bore, the cylinder having an external surface formed of compressible compliant material; a first bulbous protrusion and a second bulbous protrusion extending from the external surface of the cylinder, each of the first and second bulbous protrusions having sloped sides that meet at a crest, the first and second bulbous protrusions being longitudinally spaced apart along the longitudinal axis of the cylinder to form a central valley, each of the first and second bulbous protrusions having a first maximum diameter in the range of 1.25 inches to 3.75 inches at the crest; and a third bulbous protrusion and a fourth bulbous protrusion extending from the external surface of the cylinder, each of the third and fourth bulbous protrusions having sloped sides that meet at a crest, the third and fourth bulbous protrusions having a second maximum diameter at the crest, the second maximum diameter being less than the first maximum diameter, the third bulbous protrusion located on the cylinder between the first bulbous protrusion and the first end of the cylinder, and the fourth bulbous protrusion located on the cylinder between the second bulbous protrusion and the second end of the cylinder. The second and third bulbous protrusion cooperate with the adjacent first and second bulbous protrusions to form first and second asymmetrical valleys.

In accordance with another aspect of the foregoing implementation, the external surface of the cylinder, including the first, second, third, and fourth bulbous protrusions, has a plurality of knobs formed thereon to extend from the external surface of the cylinder. Ideally, each of the plurality of knobs has a distal end that extends from the external surface of the cylinder a third maximum diameter that is less than the second maximum diameter.

In accordance with another aspect of the foregoing implementation, the first, second, third, and fourth bulbous protrusions extend around the entire circumference of the cylinder.

In accordance with another aspect of the foregoing implementation, the cylinder is rigid along its longitudinal axis.

In accordance with another aspect of the foregoing implementation, the first and second bulbous protrusions are sized, shaped, and positioned on the cylinder to cooperate with each other to wrap partially around selected portions of the tissue.

In accordance with another aspect of the foregoing implementation, the first and second bulbous protrusions have matching cross-sectional profiles of their sloped sides.

In accordance with another aspect of the foregoing implementation, the third and fourth bulbous protrusions have matching cross-sectional profiles of their sloped sides, and the third maximum diameter is in the range of 0.75 inch to 2.5 inches.

In accordance with another aspect of the foregoing implementation, the sloped sides of the first and second bulbous protrusions are in the range of 30 degrees to and including 50 degrees relative to the longitudinal axis of the cylinder.

In accordance with still yet another aspect of the present disclosure, the range of spacing between the crests of the first and second bulbous protrusions is 3.0 inches to and including 3.8 inches.

In accordance with another implementation of the present disclosure, a soft tissue therapy tool is provided. The tool includes an elongate rigid or semi-rigid axle having first and second ends, handles for gripping on each of the first and second ends of the axle; an elongate, rigid cylinder having a first end, a second end, a longitudinal axis, and a longitudinal axial bore sized and shaped to be slidably received over the axle, the cylinder having an external surface with an external diameter, the external surface formed of compressible compliant material; a first orbicular section and a second orbicular section extending around the circumference of the external surface of the cylinder, each of the first and second orbicular sections having sloped sides that meet at a crest, the first and second orbicular sections being longitudinally spaced apart along the longitudinal axis of the cylinder and each of the first and second orbicular sections having a first maximum diameter in the range of 1.25 inches to 3.75 inches at the crest; and a third orbicular section and a fourth orbicular section extending around the circumference of the external surface of the cylinder, each of the third and fourth orbicular sections having sloped sides that meet at a crest, the third and fourth orbicular sections having a second maximum diameter at their crests that is less than the first maximum diameter of the first and second orbicular sections, the third orbicular section located on the cylinder between the first orbicular section and the first end of the cylinder, and the fourth orbicular section being located on the cylinder between the second orbicular section and the second end of the cylinder.

In accordance with another aspect of the foregoing implementation, the first and second orbicular sections have matching cross-sectional profiles of their sloped sides.

In accordance with another aspect of the foregoing implementation, the third and fourth orbicular sections have matching cross-sectional profiles of their sloped sides.

In accordance with another aspect of the foregoing implementation, the first and second orbicular sections are sized, shaped, and positioned on the cylinder to cooperate with each other to extend around selected portions of the tissue.

In accordance with another aspect of the foregoing implementation, the external surface of the cylinder, including the first, second, third, and fourth orbicular protrusions, has a plurality of knobs formed thereon to extend from the external surface.

As will be readily appreciated from the foregoing, the present disclosure provides a roller and therapy tool that includes a contoured surface that effectively wraps around select body parts. It also includes a non-flexible implementation that provides leverage to enable a user to control the compression level. High-quality handles can be provided on either side which, in cooperation with the continuous, contoured, knobby roller, enable controlled deep tissue self-massage. The roller is made of a dense, but forgiving, foam with a smooth finish. Its contoured shape fits the leg well and the knobby, bulbous (e.g., orbicular) protrusions or sections can be used for more precise massage work, such as targeting, for example, the piriformis, tibialis anterior (along the shins) and even the balls of the feet. The knobs are a firm foam and succeed at providing resistance as well as give. In one implementation, an axle is provided with hand grips to facilitate manual use in rolling the tool.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is an isometric view of a soft tissue therapy roller formed in accordance with the present disclosure that includes a roller having encircling protrusions with a knobby surface formed on an exterior surface thereof;

FIG. 2 is a front elevation view of the soft tissue therapy roller of FIG. 1;

FIG. 3 is a left side elevation view of the roller of FIG. 1;

FIG. 4 is a cross section taken along lines 4-4 of the roller of FIG. 2;

FIG. 5 is an enlarged cross section of Detail 5 from FIG. 4;

FIG. 6 is a cross section taken along lines 6-6 of the roller of FIG. 2;

FIG. 7 is a cross section taken along lines 7-7 of the roller of FIG. 2;

FIG. 8 is an isometric view of a soft tissue therapy tool formed in accordance with an alternative implementation of the present disclosure; and

FIG. 9 is a cross section of the soft tissue therapy tool of FIG. 8.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with foam rollers and massage tools have not been shown or described in detail to avoid unnecessarily obscuring descriptions of the implementations. Reference to “device” and “tool” is intended be inclusive of, without limitation, foam rollers that do not have handles as well as to massage sticks that have handles and a roller mounted on a spindle.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one implementation” or “an implementation” means that a particular feature, structure or characteristic described in connection with the implementation is included in at least one implementation. Thus, the appearance of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

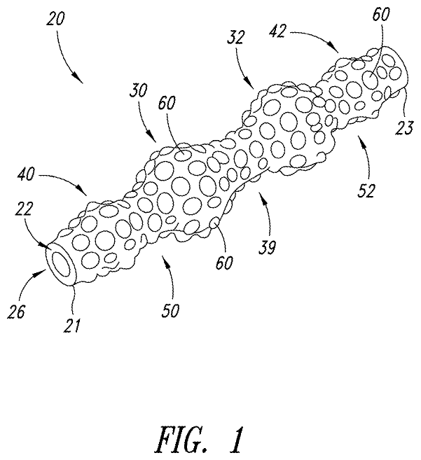

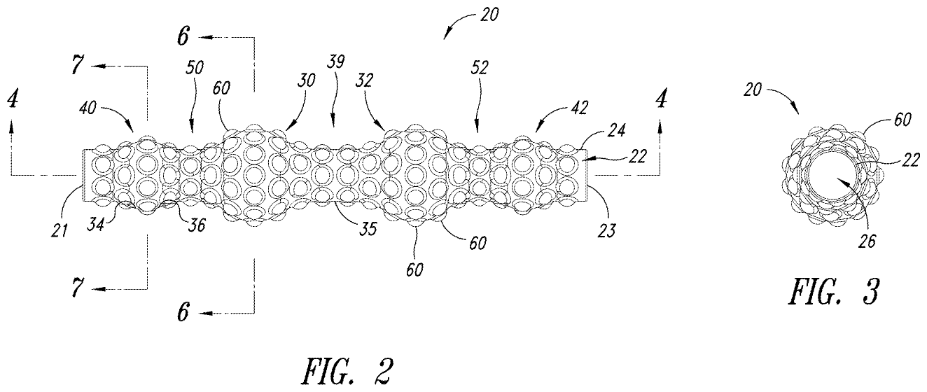

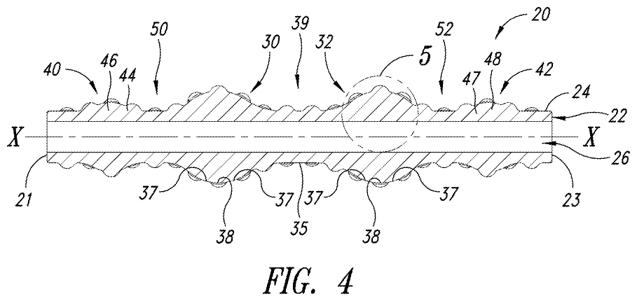

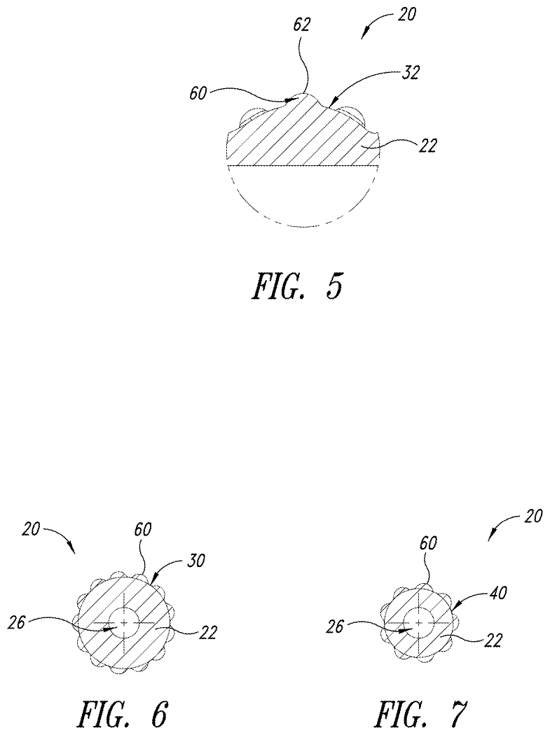

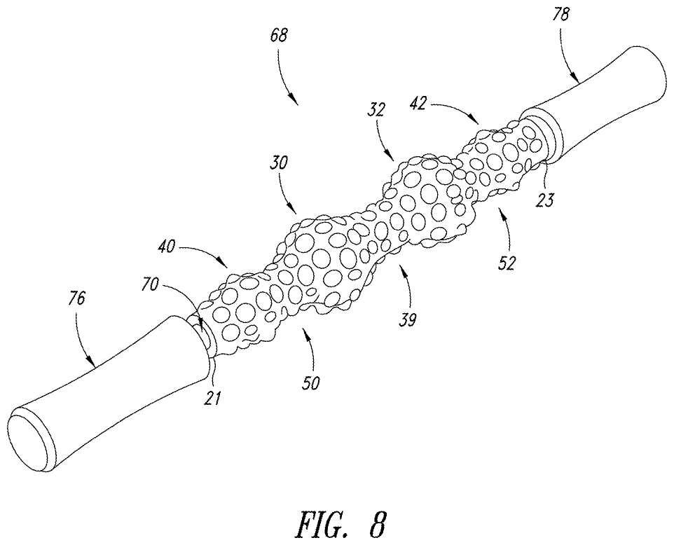

Referring to FIGS. 1-7, shown therein is a representative implementation of a massage device formed in accordance with the present disclosure. In this implementation the device consists of a stick-type foam massage roller 20 that includes a core 22 in the shape of a cylinder having a first end 21, a second end 23, and an external surface 24 formed of compressible compliant material. The core 22 has an interior 26 that can be hollow or it may be filled, solid, or some combination of the foregoing. If the interior 26 of the core 22 is partially filled, filled, or solid, the interior 26 may be rigid or semi-rigid. The core 22 or the partially filled, filled, or solid interior 26 may be formed of material that provides rigidity or semi-rigidity to the roller 20. As shown in FIG. 4, in this implementation, the interior 26 is a longitudinal axial bore having a longitudinal axis X. The exterior or external surface 24 is preferably formed of non-toxic, latex free, closed-cell EVA (ethylene-vinyl acetate copolymer) or polyolefin foam. As described more fully below, the external surface 24 preferably has a smooth, closed-cell construction with a plurality of knobs 60 formed thereon.

A first bulbous protrusion 30 and a second bulbous protrusion 32 extend from the external surface 24 of the core 22. The first bulbous protrusion 30 has sloped sides 34 that meet at a crest 36 and the second bulbous protrusion has sloped sides 37 that meet at a crest 38. The first and second bulbous protrusions 30, 32 are longitudinally spaced apart along the longitudinal axis of the core 22 to form a central valley 39 therebetween. In one implementation, the valley 39 has a relatively flat floor 35 midway between the first and second bulbous protrusions 30, 32. Each of the first and second bulbous protrusions 30, 32 also have a first maximum diameter in the range of 1.25 inches to 3.75 inches at the respective crests 36, 38. Ideally, the first and second bulbous protrusions 30, 32 have matching cross-sectional profiles of their sloped sides. In one implementation, the first and second bulbous protrusions 30, 32 have a diameter in the range of 1.25 inch to and including 3.75 inch. In accordance with a preferred aspect of this implementation, the first and second bulbous protrusions 30, 32 are integrally formed with the core 22 and are sized, shaped, and positioned on the core 22 to cooperate with each other when in use to wrap partially around selected portions of a user's tissue.

In accordance with a preferred aspect of the present implementation, the sloped sides 37 of the first and second bulbous protrusions 30, 32 have a slope in the range of 30 degrees to and including 50 degrees relative to the longitudinal axis of the core 22. Ideally the range of spacing between the crests 38 of the first and second bulbous protrusions 30, 32 is 3.0 inches to and including 3.8 inches.

A third bulbous protrusion 40 and a fourth bulbous protrusion 42 extend from the external surface 24 of the core 22. As shown in FIG. 4, the third bulbous protrusion 40 has sloped sides 44 that meet at a crest 46, and the fourth bulbous protrusion 42 has sloped sides 47 that meet at a crest 48. The third and fourth bulbous protrusions 40, 42 each have a second maximum diameter at their respective crests 46, 48, the second maximum diameter being less than the first maximum diameter, and preferably in the range of 0.75 inch to and including 2.5 inches. In this implementation, the third bulbous protrusion 40 is located on the core 22 between the first bulbous protrusion 30 and the first end 21 of the core 22, and the fourth bulbous protrusion 42 is located on the core 22 between the second bulbous protrusion 32 and the second end 23 of the core 22. Ideally, the third and fourth bulbous protrusions 40, 42 cooperate with the adjacent respective first and second bulbous protrusions 30, 32 to form respective first and second asymmetrical valleys 50, 52, as explained in more detail below. Preferably, the third and fourth bulbous protrusions 40, 42 have matching cross-sectional profiles of their sloped sides 44.

As illustrated, each of the first, second, third, and fourth bulbous protrusions 30, 32, 40, 42 have an orbicular configuration, and as such they extend uniformly around the entire circumference of the core 22.

In accordance with another implementation of the present disclosure, the core 22, including the first, second, third, and fourth bulbous protrusions 30, 32, 40, 42, has a plurality of knobs 60 formed thereon to extend from the external surface 24. Each of the plurality of knobs 60 has a distal end 62 that extends from the external surface 24 of the core 22 a third maximum diameter to its distal end 62. In accordance with one aspect of the present disclosure, each knob extends a distance from 0.0625 inch to and including 0.5 inch from the external surface 24 to the distal end 62. Ideally, each knob 60 has a width in the range of 0.125 inch to and including 0.625 inch.

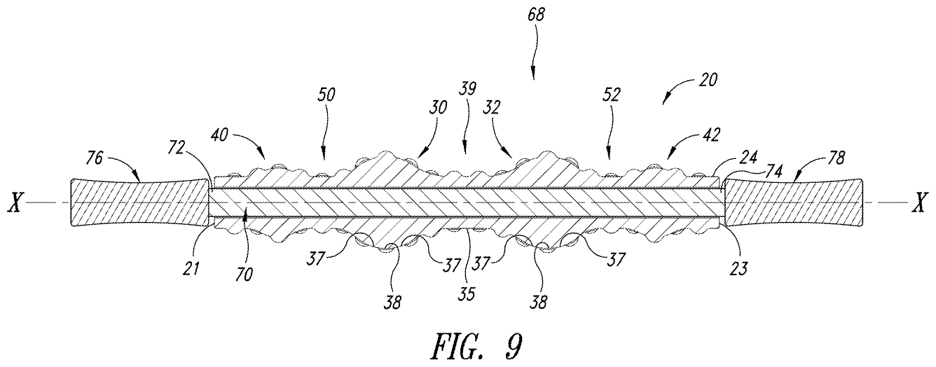

FIGS. 8 and 9 illustrate yet another implementation of the present disclosure in which the roller 20 described above becomes a therapy tool 68 by incorporating an axle 70 having first and second ends 72, 74. Ideally, each of the first and second ends 72, 74 forms or has mounted thereon hand grips 76, 78 to facilitate grasping by the user. While the axle 70 may be rigid and unbendable, it can also be formed to have a slight amount of flex to facilitate use as described below.

In use, the shape of the roller 20 and the tool 68 also lends itself to helping with back massage. For example, the user will place the roller 20 or tool 68 on the ground and lay on it, lining up their erector spinae (muscles that run the length of the spine on either side) and gently roll back and forth. The smaller third and fourth bulbous protrusions 40, 42 can be used for a focused massage that is not as aggressive as the larger first and second bulbous protrusions 30, 32. In addition, the smaller third and fourth bulbous protrusions 40, 42 are closer in proximity to the respective larger first and second bulbous protrusions 30, 32 than the first and second bulbous protrusions 30, 32 are to each other. This spacing provides for a wrap-around massage effect for smaller diameter regions of the body, such as just above the ankle, lower calf, Achilles tendon, and forearm. For larger muscle groups, such as quadriceps, hamstring, belly of calf muscle, the valley 39 in cooperation with the larger first and second bulbous protrusions 30, 32 creates a similar wrap-around effect.

The various implementations described above can be combined to provide further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A contoured soft tissue therapy roller, comprising:
a cylinder having a first end, a second end, a longitudinal axis, and a longitudinal axial bore, the cylinder having an external surface formed of compressible compliant material;
a first bulbous protrusion and a second bulbous protrusion extending from the external surface of the cylinder, the first bulbous protrusion having sloped sides that meet at a crest and the second bulbous protrusion having sloped sides that meet at a crest, the first and second bulbous protrusions being longitudinally spaced apart along the longitudinal axis of the cylinder to form a central valley therebetween, each of the first and second bulbous protrusions having a first maximum diameter in the range of 1.25 inches to and including 3.75 inches at the respective crest; and
a third bulbous protrusion and a fourth bulbous protrusion extending from the external surface of the cylinder, the third bulbous protrusion having sloped sides that meet at a crest and the fourth bulbous protrusion having sloped sides that meet at a crest, the third and fourth bulbous protrusions having a second maximum diameter at the crest, the second maximum diameter being less than the first maximum diameter, the third bulbous protrusion located on the cylinder between the first bulbous protrusion and the first end of the cylinder, and the fourth bulbous protrusion located on the cylinder between the second bulbous protrusion and the second end of the cylinder, the third and fourth bulbous protrusions cooperating with the adjacent respective first and second bulbous protrusions to form respective first and second asymmetrical valleys.

2. The contoured soft tissue therapy roller of claim 1, wherein the external surface of the cylinder, including the first, second, third, and fourth bulbous protrusions, has a plurality of knobs formed thereon to extend from the external surface of the cylinder.

3. The contoured soft tissue therapy roller of claim 2 wherein each of the plurality of knobs have a distal end that extends from the external surface of the cylinder a third maximum diameter.

4. The contoured soft tissue therapy roller of claim 1, wherein the first, second, third, and fourth bulbous protrusions extend around the entire circumference of the cylinder.

5. The contoured soft tissue therapy roller of claim 1 wherein the cylinder is rigid along its longitudinal axis.

6. The contoured soft tissue therapy roller of claim 1 wherein the first and second bulbous protrusions are sized, shaped, and positioned on the cylinder to cooperate with each other to wrap partially around selected portions of the tissue.

7. The contoured soft tissue therapy roller of claim 4 wherein the first and second bulbous protrusions have matching cross-sectional profiles of their sloped sides.

8. The contoured soft tissue therapy roller of claim 4 wherein the third and fourth bulbous protrusions have matching cross-sectional profiles of their sloped sides, and the third maximum diameter being in the range of 0.75 inch to and including 2.5 inches.

9. The contoured soft tissue therapy roller of claim 1 wherein the sloped sides of the first and second bulbous protrusions are in the range of 30 degrees to and including 50 degrees relative to the longitudinal axis of the cylinder.

10. The contoured soft tissue therapy roller of claim 1 wherein the range of spacing between the crests of the first and second bulbous protrusions is 3.0 inches to and including 3.8 inches.

11. A soft tissue therapy tool, comprising:
an elongate semi-rigid axle having first and second ends;
an elongate, rigid cylinder having a first end, a second end, a longitudinal axis, and a longitudinal axial bore sized and shaped to be slidably received over the axle, the cylinder having an external surface with an external diameter, the external surface formed of compressible compliant material;
a first orbicular section and a second orbicular section extending around the circumference of the external surface of the cylinder, each of the first and second orbicular sections having sloped sides that meet at a crest, the first and second orbicular sections being longitudinally spaced apart along the longitudinal axis of the cylinder and each of the first and second orbicular sections having a first maximum diameter in the range of 1.25 inches to 3.75 inches at the crest; and
a third orbicular section and a fourth orbicular section extending around the circumference of the external surface of the cylinder, each of the third and fourth orbicular sections having sloped sides that meet at a crest, the third and fourth orbicular sections having a second maximum diameter at their crests that is less than the first maximum diameter of the first and second orbicular sections, the third orbicular section located on the cylinder between the first orbicular section and the first end of the cylinder, and the fourth orbicular section being located on the cylinder between the second orbicular section and the second end of the cylinder.

12. The soft tissue therapy tool of claim 11, wherein the first and second orbicular sections have matching cross-sectional profiles of their sloped sides.

13. The soft tissue therapy tool of claim 11 wherein the third and fourth orbicular sections have matching cross-sectional profiles of their sloped sides.

14. The soft tissue therapy tool of claim 11, wherein the first and second orbicular sections are sized, shaped, and positioned on the cylinder to cooperate with each other to extend around selected portions of the tissue.

15. The soft tissue therapy tool of claim 11 wherein the sloped sides of the first and second orbicular sections are in the range of 30 degrees to and including 50 degrees relative to the longitudinal axis of the cylinder.

16. The contoured soft tissue therapy roller of claim 1 wherein the range of spacing between the crests of the first and second bulbous protrusions is 3.0 inches to 3.8 inches.

17. The soft tissue therapy tool of claim 11, wherein the external surface of the cylinder, including the first, second, third, and fourth orbicular sections, has a plurality of knobs formed thereon to extend from the external surface.
